(19) United States
(12) Patent Application Publication
(10) Pub. No.: US 2026/0267286 A1
(43) Pub. Date: Sep. 10, 2026

(54) Watch Winder Drawer

(71) Applicant: Mt Tremper Holdings, LLC, White Plains, NY (US)

(72) Inventors: Robert Blum, White Plains, NY (US); David Kuntz, White Plains, NY (US)

(73) Assignee: Mt Tremper Holdings, LLC, White Plains, NY (US)

(21) Appl. No.: 19/546,992

(22) Filed: Feb. 23, 2026

Related U.S. Application Data
(60) Provisional application No. 63/762,339, filed on Feb. 24, 2025.

(51) Int. Cl. G04B 3/00

(52) U.S. Cl. CPC G04B 3/006

(57) ABSTRACT

A watch winder drawer kit for installation in a drawer of a piece of furniture includes a base and a plurality of watch winder units. Each watch winder unit is pivotally attached to the base to permit movement between a stored position and a display position. A motorized first mechanism is provided for controllably moving the watch winder units between the stored positions and the display positions. A sensor mechanism is configured to determine whether the drawer is in a closed position or open position and a main controller is operatively coupled to the motorized first mechanism and the sensing mechanism. The main controller is configured to send: to cause the plurality of watch winder units to move between the stored positions and the display positions when the sensor mechanism detects that the drawer is in the open position.

### CROSS REFERENCE TO RELATED APPLICATION

The present application claims the benefit of and priority to US patent application Serial No. 63/762,339, filed Feb. 24, 2025, which is hereby incorporated by reference in its entirety.

### TECHNICAL FIELD

The present application relates to a piece of furniture and more particularly, relates to specialized furniture in the form of a watch winder drawer that holds a plurality of watch winders and is configured such that the watch winders automatically move between a stored position and a display position when the drawer is opened.

### BACKGROUND

Automatic (i.e., self-winding) watches have their mainsprings wound either manually by the owner turning the watch stem, or more typically, through motion of the watch on the wrist or a watch winder, which moves a rotor in the watch movement that transfers this motion to wind the watch’s mainspring. Because of the nature of the watch movement’s construction and rotor orientation, optimally the watch should be positioned between 80-90 degrees when in a watch winder (i.e., with the watch face roughly perpendicular with the horizontal surface upon which the winder sits). However, if a watch winder is in a drawer, sitting at 90 degrees makes the watch face difficult to see when the drawer is opened, and a 60-65 degree viewing angle is more optimal for viewing. Fine watches are treated by many of their owners as art pieces, and therefore viewability is important.

### SUMMARY

A watch winder drawer kit for installation in a drawer of a piece of furniture is disclosed. The kit includes a base that has a top surface and an opposite bottom surface. The kit further includes a plurality of watch winder units, each watch winder having a housing that contains a plurality of rotatable watch winders. Each watch winder unit is pivotally attached to the base to permit movement between a stored position and a display position. A motorized first mechanism is provided for controllably moving the watch winder units between the stored positions and the display positions. A sensor mechanism is configured to determine whether the drawer is in a closed position or open position and a main controller is operatively coupled to the motorized first mechanism and the sensing mechanism. The main controller is configured to send: (1) a first motor control signal to the motorized first mechanism to cause the plurality of watch winder units to move from the stored positions to the display positions when the sensor mechanism detects that the drawer is in the open position; and (2) a second motor control signal to the motorized first mechanism to cause the plurality of watch winder units to move from the display positions to the stored positions when the sensor mechanism detects that the drawer is being closed.

### BRIEF DESCRIPTION OF THE DRAWING FIGURES

FIG. 1 is a top and side perspective view of a piece of furniture with a drawer shown in the open position;

FIG. 2 is a top plan of a watch winder drawer kit in accordance with one embodiment and being shown installed in an open drawer;

FIG. 3 is closeup view of a sensor that is configured to detect whether the drawer is in the open position or closed position;

FIG. 4 is a perspective view of a part of the sensor;

FIG. 5 is a top perspective view of the drawer in the open position with the watch winder units in raised, display positions;

FIG. 6 is a perspective view of the watch winder drawer kit in accordance with one embodiment and being installed in a drawer, with the watch winder units in lowered, stored positions;

FIG. 7 is a bottom plan view of a base of the watch winder drawer kit;

FIG. 8 is a partial top perspective view of a motorized linkage mechanism for controlling the automated movement of the watch winder units between the raised, display positions and the lowered, stored positions;

FIG. 9A is a side elevation view of the motorized linkage mechanism and the watch winder units in the lowered, stored positions; and

FIG. 9B is a side elevation view of the motorized linkage mechanism and the watch winder units in the raised, display positions.

### DETAILED DESCRIPTION OF CERTAIN EMBODIMENTS

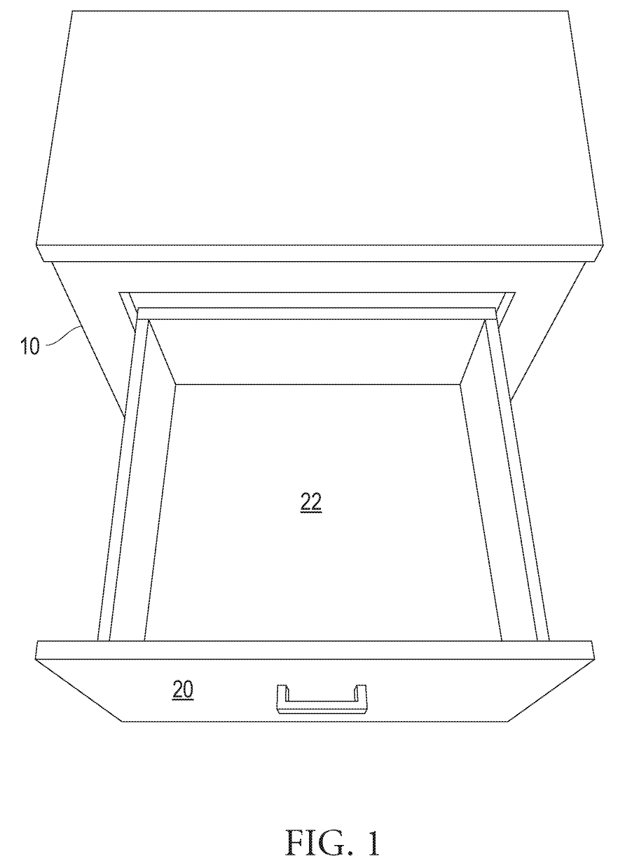

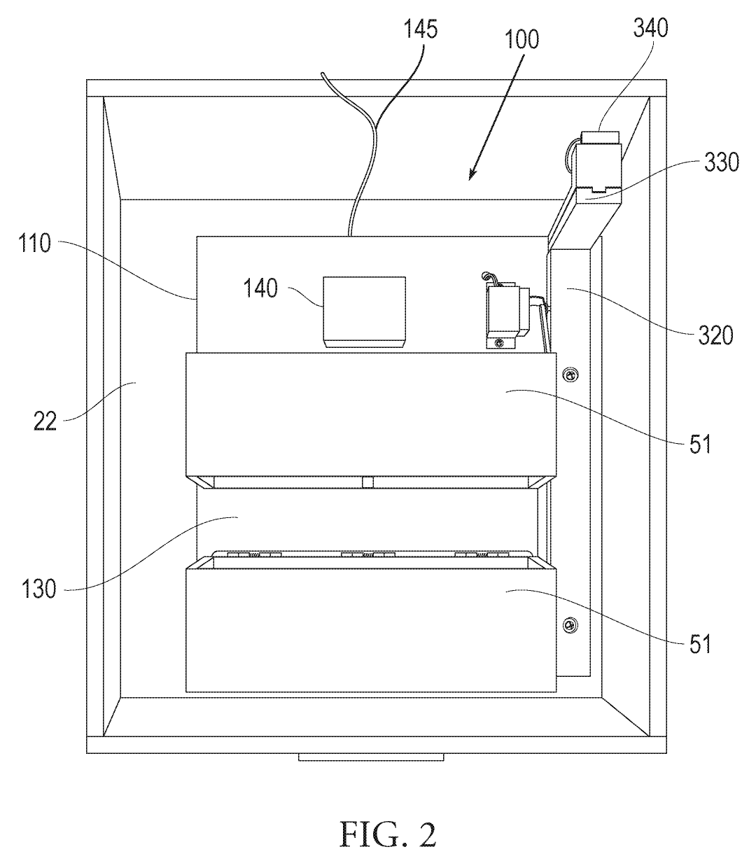

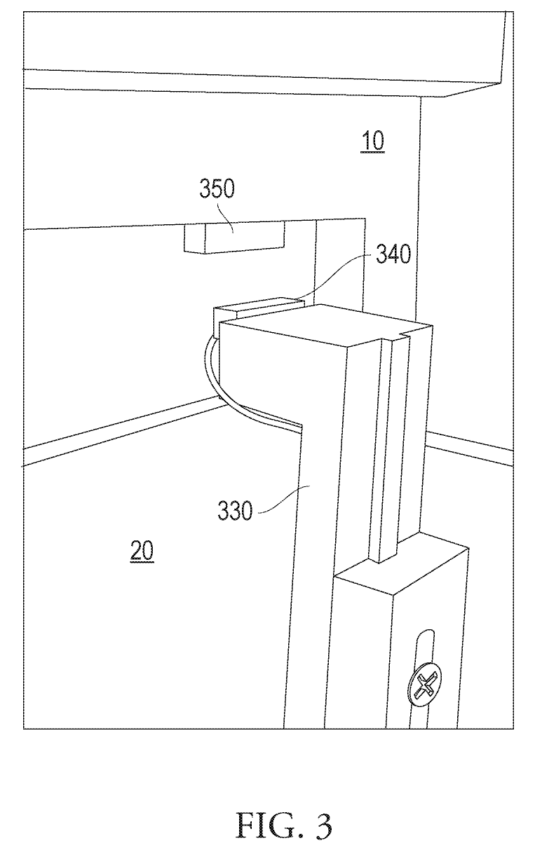

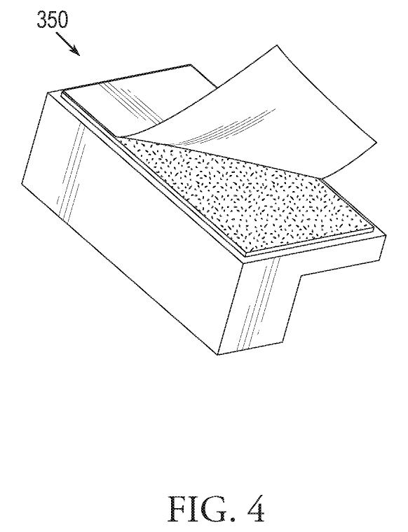

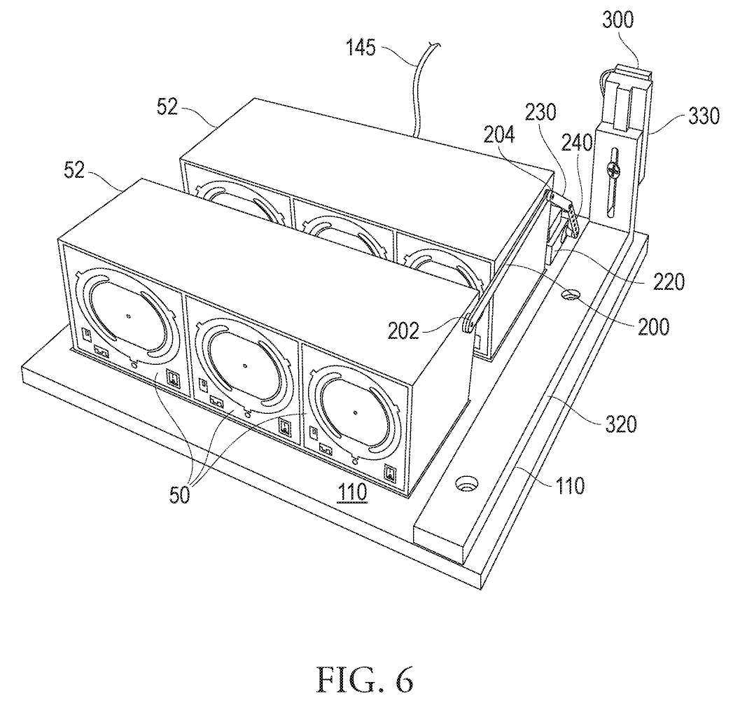

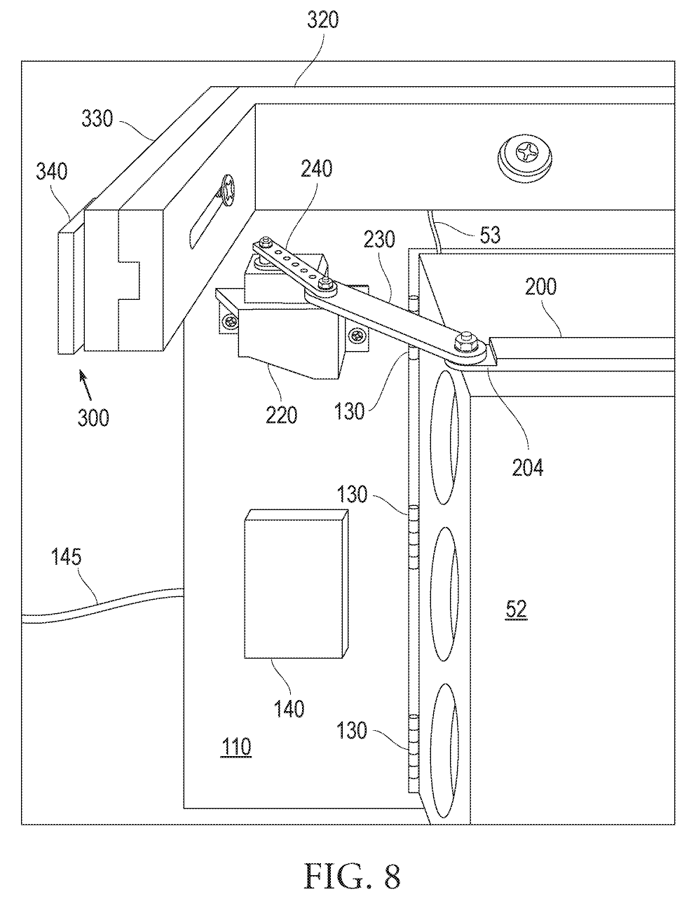

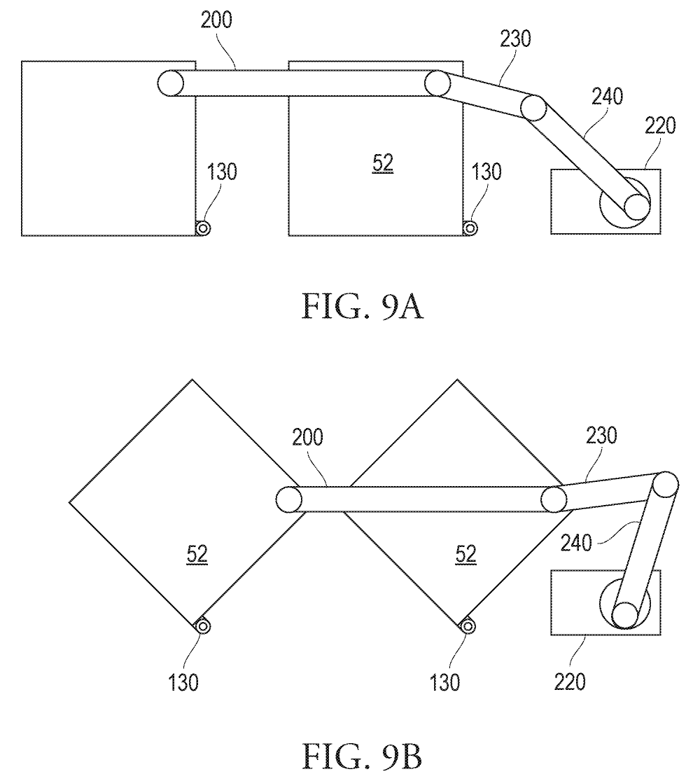

With reference to the appended FIGS. 1-9B, a piece of furniture 10 is illustrated. The piece of furniture 10 is of a type that includes one or more drawers 20. For example, the piece of furniture 10 can be a cabinet, credenza, bookcase, desk, etc. The drawer 20 can be of any traditional kind and typically, the drawer 20 is coupled to the furniture 10 by means of drawer hardware, such as drawer slides.

In a first embodiment, a watch winder drawer kit or accessory 100 is provided for being retrofittably mounted to an existing drawer 20. Alternatively, as discussed herein, in a second embodiment, the drawer 20 can be a custom drawer in which the watch winder drawer accessory is incorporated and is not retrofitted.

The first embodiment is illustrated in appended figures.

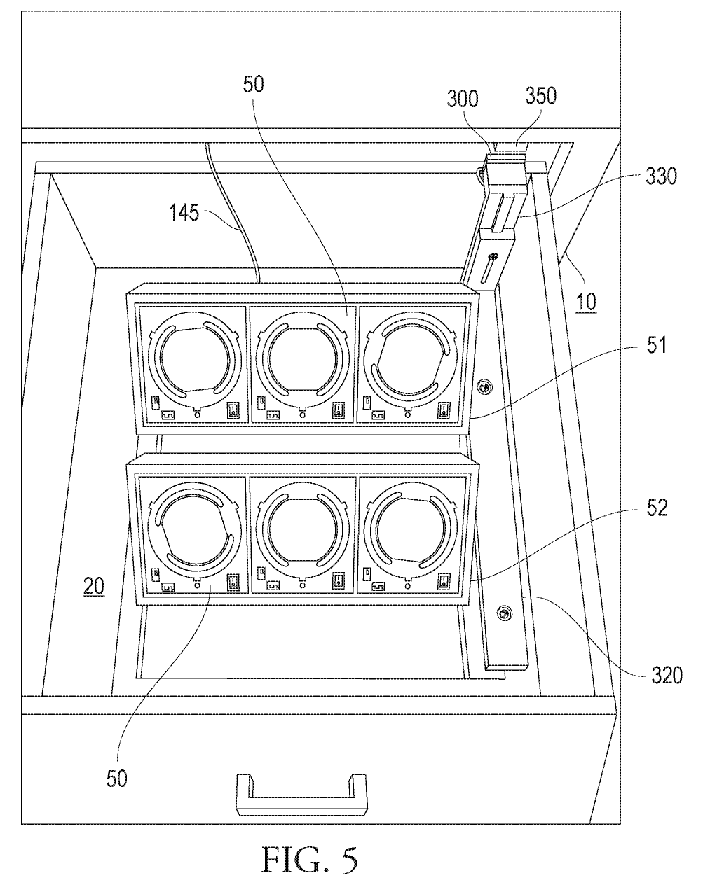

The watch winder drawer kit 100 includes at least one row of one or more watch winders 50. In the illustrated embodiment, there are two rows of watch winders 50, with each row including a plurality of watch winders 50. In the illustrated embodiment, each row of watch winders 50 includes three watch winders 50 arranged in series (side-by-side). The watch winders 50 in one given row are typically contained in a single housing 52 and thus, comprise a single watch winder unit, generally indicated at 51, that contains plural watch winders 50. The watch winder unit 51 is thus a single structure that contains plural watch winders 50 (See, FIG. 5).

The housing can be made of wood or metal or other suitable material. Within the single housing 52 are the individual watch winders 50, as well as the electronics (PCB/controls) and motors to cause controlled rotation of each watch winder 50. Each watch winder unit 51 is a powered unit that requires electric power, such is most often supplied by a power cord that connects to an electric outlet. As described herein, the watch winder drawer kit 100 is specifically designed such that the power for each watch winder unit 51 comes from a single source in that a single power and control module is provided to power each watch winder unit 51.

The watch winder drawer kit 100 includes a base 110 that is configured to be received into the drawer 20 and be mounted to a floor 22 of the drawer. For example, one edge of the base 110 can include a bracket or the like that allows the base 110 to be attached to a wall of the drawer 20. Other mounting techniques are equally possible. The base 110 preferably includes one or more openings or through holes 120. In particular, for each watch winder unit 51, there is an associated through hole 120. Each watch winder unit 51, as described herein, is pivotably coupled to the base 110 and lies above and/or partially within one corresponding through hole 120. For example, each watch winder unit 51 can be pivotally attached to the base 110 by one or more spring-loaded hinges 130. One part of the spring-loaded hinge 130 can be attached to one edge of the through hole 120 and the other part of the spring-loaded hinge 130 is attached to the rear edge of the housing 52. These spring-loaded hinges 130 allow the watch winder units 51 to pivot, in a controlled manner, between the stored positions and the display positions.

Each watch winder unit 51 has an associated power wire or cable 53 that provides power to the watch winders 50 contained in the housing 52.

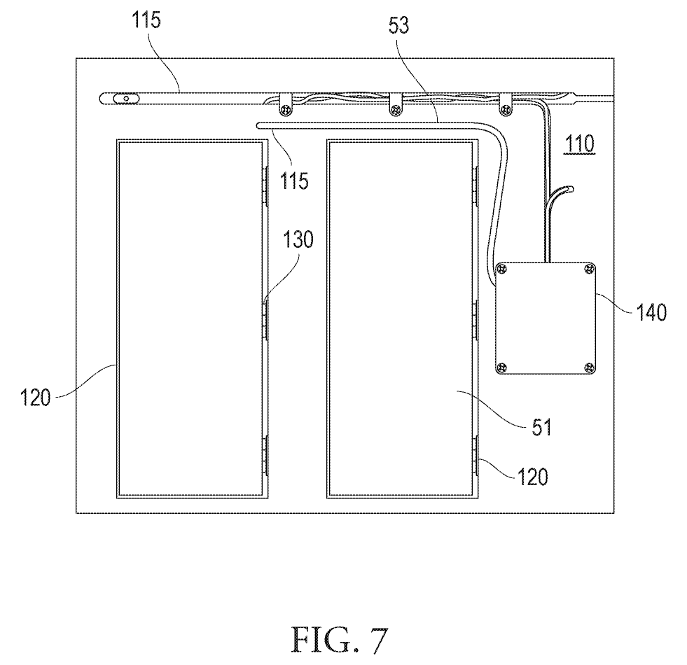

As shown in the figures(FIG. 7), the underside of the base 110 can be customized to include channeling 115 and other features for routing cables, such as cable 53, along the underside to a target location. In particular, the watch winder drawer kit 100 has a main controller (power module/power adapter) 140 for delivering and controlling power to each watch winder unit 51. The main controller 140 can be mounted along the underside within a recessed area, etc.

It will be appreciated that the base 110 does not have to occupy the entire space of the floor 22; however, it can occupy substantially the entire space in one embodiment.

The watch winder drawer kit 100 also includes a mechanism for controllably pivoting each watch winder unit 51 between the stored position and the display position. For example, in the stored position, each watch winder unit 51 is oriented at or approximately at 90 degrees relative to the base 110 and in the display position, each watch winder unit 51 is oriented at or approximately at 60 degrees relative to the base 110. It will be appreciated and understood that other display angles can be equally used. Thus, in the display position, the watch winder unit 51 is titled upward in the front thereof.

It will be appreciated that the display position can be set to other angles, such as an angle between 50 degrees and 70 degrees or other angle that permits display and viewing of the watches. It is also possible that the main controller can permit the user to input the angle of display, such as by a menu on a digital display or by a manual switch that say has multiple settings, such as 50 degrees, 60 degrees, and 70 degrees. Thus, the display angle is any angle that permits viewing and display of the watches and similarly, the stored position is an angle that permits storing and winding of the watches and is not limited to a 90 degree angle.

The mechanism can comprise a first link 200 that attaches to first ends of the watch winder units 51. The first link 200 can thus be an elongated rail or bar of the like that is secured to the first ends by fasteners or other mounting hardware. The first link 200 is thus at a fixed location along the watch winder units 51 (e.g., within the top 25% or top 10% of the height of the unit). In the event of two watch winder units 51, as shown, a first end 202 of the first link 200 is attached to a rear section of the forward most watch winder unit 51, while an opposite second end 204 of the first link 200 is attached to the rearward most watch winder unit 51. The second end 204 can be at or close to the rear edge of the watch winder unit 51.

The mechanism is a motorized mechanism and includes a motor 220, e.g., a servo motor, that is operably coupled to the linkage. For example, the motor 220 can be coupled to first link 200 by means of a second link 230 and a third link 240. The second link 230 is pivotally coupled to the second end 204 of the first link 200 and is pivotally coupled to the third link 240. The opposite end of the third link 240 is operatively coupled to the motor 220 and more particularly, the third link 240 can be coupled to a main rotating shaft of the motor 220.

As is known, a servo motor, e.g., the servo motor 220, is a rotary or linear actuator that allows for precise control of angular or linear position, velocity, and acceleration in a mechanical system. In the present application, the servo motor comprises a rotary actuator that allows for precise control of angular position. In particular, precise control of the rotation of the servo motor’s shaft allows for precise translation of the linkage. In particular, when the watch winder units 51 are in the stored position (90 degrees relative to the base 110), the linkage is in a first position, and to achieve the display position (60 degrees relative to the base 110), the motor 220 operates and rotation of the main shaft causes the linkage to be pulled toward the motor 220 (i.e., in a direction toward the rear of the drawer). More specifically, the second and third links 230, 240 pivot under operation of the motor 220 and pull the fixed first link 200 toward the motor 220. As the first link 200 is pulled rearward, the watch winder units 51 pivot upward along a pivot axis defined by the spring-located hinges 130. Pivoting of the watch winder units 51 results due to the location of the first link 200 close to the tops (e.g., top 25%) of the watch winder units 51 and the spring-loaded hinges 130. This pivoting action result in the watch winder units 51 moving from the stored position to the display position. For example, this action results in a 30 degree tilting (pivoting) of the watch winder units 51.

As shown, the motor 220 is mounted to the top surface of the base 110.

The motor 220 is a powered unit and thus is connected to the power source via the power module embodied in the main controller 140. In other words, a wire can connect the motor 220 to the main controller 140.

The main controller 140 is thus electrically connected to each watch winder unit 51 and to the motor 220 for providing power (energy) to each of these devices. The main controller 140 can have a single power cord 145 that is for electrically connected to a power source, such as an electrical outlet in a room. The power cord 145 extends outward from the main controller 140 and can be routed within the drawer 20 and the furniture 10. For example, the drawer 20 itself can have an opening or hole through which the power cord 145 is routed. From the drawer 20, the power cord 145 can be routed internally within the furniture 10 to an exit location. For example, a rear wall of the drawer 20 can include a hole through which the power cord 145 is routed through.

It will be appreciated that the above-described mechanism(s) are merely exemplary in nature and other type of mechanical linkages or the like can be constructed to cause the pivoting of the watch winder units. For example, other types of possible mechanisms include the following. A rotary actuator (direct hinge drive) that mounts at or replaces the hinge and directly rotates the door a number of degrees. This can be electric (DC motor + gearbox) and can include position control to stop at, say, 5–10°. Another type of mechanism is a linear actuator (push/pull-type mechanism) that extends slightly and pull/pushes the winder. Other types of servo motor (controlled rotation), gear motor with cam or crank, and spring-assist and solenoid release.

In one embodiment, the watch winder unit 51 contains separate, independently powered watch winders (e.g., Boxy winders) that are inserted into the housing of the watch winder unit 51 and are removable for service. The Boxy winders have adjustable settings for the number of rotations per day and direction of rotation. The watch winder units 51 can be available in either 3, 4 or 5 winders wide formats (i.e., 6, 8 or 10 winders per drawer).

An actuator is provided for controlling the operation and for causing the automatic movement of the watch winder units 51 between the stored and display positions. The actuator is of a type that has a sensor that automatically senses when the drawer 20 is opened and upon sensing that the drawer 20 is being opened, a first sensor control signal is sent to the servo motor 220. The actuator is operatively connected to the main controller 140 to allow the control signal to be delivered to the main controller 140. Upon receiving the first sensor control signal from the actuator, the main controller 140 sends a first motor control signal to the servo motor 220 to cause rotation of the shaft of the servo motor in a first direction.

In one embodiment, the actuator comprises a magnetic sensor 300. As is known, a magnetic sensor works by detecting changes in a magnetic field, converting the strength and direction of that field into an electrical signal through a phenomenon like the Hall effect or magnetoresistance, where the electrical resistance of a material varies depending on the strength and direction of the applied magnetic field; essentially, it translates magnetic flux into an electrical output that can be measured and interpreted by a system. In the present application, when the drawer 20 opens, a change in magnetic field is observed and this causes the first sensor control signal to be sent to the main controller 140 and in turn the first motor control signal is sent to the motor 220 to cause the watch winder units 51 to pivot to the display positions (60 degrees). In contrast, as the drawer is closed, a change in magnetic field is observed and this causes a second sensor control signal to be sent to the main controller 140 and in turn a second motor control signal is sent to the motor 220 to cause the watch winder units 51 to pivot back to the stored positions (90 degrees) as a result of rotation of the motor shaft in an opposite second direction. It will therefore be appreciated that the direction of rotation of the motor shaft results in the linkage either being pulled toward to the motor (and thus pivoting the watch winder units 51 to the display positions) or pushed away from the motor (and thus pivoting the watch winder units 51 to the stored positions).

In the illustrated embodiment, the magnetic sensor comprises a base 320 and a vertically oriented sensor arm 330. For example, the sensor arm 330 can at a 90-degree angle relative to the base 320. The base 320 is fixedly attached to the top surface of the base 110. The sensor arm 330 is height adjustable. At a top end of the sensor arm 330, there is a first magnetic sensor part in the form of a magnetic sensing element 340. The magnetic sensing element 340 is operatively connected to the main controller 140. A permanent magnet 350 is mounted to the furniture 10. The permanent magnet 350 is used to generate the magnetic field. The sensing element 340 (like a Hall effect transducer or a magnetoresistance element) detects changes in the magnetic field, and signal conditioning circuitry to process the raw electrical signal from the sensing element into a usable output in the form of a control signal delivered to the main controller 140.

The permanent magnet 350 can be part of an adhesive pad that is intended to be adhesively attached to a surface of the furniture. Such as at a front edge of the drawer opening formed in the furniture 10. When the permanent magnet 350 is at this location at the front edge of the drawer opening, the system operates as follows. When the drawer 20 is closed, the permanent magnet 350 is not near the sensing element 340 and thus, the watch winder units 51 are in the stored positions. When the drawer 20 is fully opened, the permanent magnet 350 is brought into close proximity to the sensing element 340. The sensing element 340 detects the presence of the magnetic field and the control signal is generated to cause operation of the motor 220 and the watch winder units 51 pivot to the display positions. In contrast, when the drawer is closed, the permanent magnet 350 travels away from the sensing element 340 and the magnetic field is not sensed by the sensing element 340 resulting in the other control signal being sent to the main controller causing the servo motor to operate to cause the watch winder units 51 to move from the display positions (optimal viewing angle) to the stored positions (optimal winding angle).

It will be appreciated that other types of actuators can be used and function in a similar manner. For example, the actuator can be in the form of a plunger switch. As is known, a plunger switch is a mechanical switch that uses a plunger to open or close an electrical circuit. Plunger switches are used in many applications, including door contacts, conveyor systems, and industrial equipment. A plunger switch has a spring-loaded plunger that is pressed or pulled by an object. When the plunger is pressed, it opens or closes the electrical circuit. This type of sensor can be referred to as being a microswitch. Other types of switches and sensor, such as optical/infrared sensors, etc., are equally possible to detect that the drawer has assumed a fully open position.

As mentioned, in an alternative second embodiment, the watch winder drawer accessory can be part of a custom drawer construction as opposed to being a kit that is retrofitted into an existing drawer. In this embodiment, the motor, electronics and the sensor mechanism are mounted directly to the floor of the drawer. The floor can include recessed areas or openings like those form in the base 110 to allow inclusion of the spring-biased hinges and to accommodate the pivoting action of the watch winder units. The drawer can include integral channeling and spaces to accommodate the working components of the system.

The watch winder drawer kit/accessory is a unique product in the market that serves the needs of watch collectors who would like to store their automatic watches out of site, in a drawer, rather than in a safe or a desktop winder.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to producenumerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. A watch winder drawer kit for installation in a drawer of a piece of furniture comprising:
a base having a top surface and an opposite bottom surface;
a plurality of watch winder units, each watch winder having a housing that contains a plurality of rotatable watch winders, each watch winder unit being pivotally attached to the base to permit movement between a stored position and a display position;
a motorized first mechanism for controllably moving the plurality of watch winder units between the stored positions and the display positions;
a sensor mechanism configured to determine whether the drawer is in a closed position or open position; and
a main controller operatively coupled to the motorized first mechanism and the sensor mechanism, the main controller being configured to send: (1) a first motor control signal to the motorized first mechanism to cause the plurality of watch winder units to move from the stored positions to the display positions when the sensor mechanism detects that the drawer is in the open position; and (2) a second motor control signal to the motorized first mechanism to cause the plurality of watch winder units to move from the display positions to the stored positions when the sensor mechanism detects that the drawer is being closed.

2. The watch winder drawer kit of claim 1, wherein the base includes a plurality of openings that have footprints greater than footprints of the watch winder units, wherein each watch winder unit is disposed over or partially within one corresponding opening formed in the base.

3. The watch winder drawer kit of claim 1, wherein each watch winder unit is pivotally attached to the base by a spring-loaded hinge.

4. The watch winder drawer kit of claim 2, wherein each watch winder unit is pivotally attached to the base by a spring-loaded hinge that is attached to one edge of the corresponding opening.

5. The watch winder drawer kit of claim 1, wherein the motorized first mechanism comprises a motor and a linkage that is coupled to each of the watch winder unit.

6. The watch winder drawer kit of claim 5, wherein the motor comprises a servo motor that is operatively coupled to the main controller.

7. The watch winder drawer kit of claim 5, wherein the linkage comprises a first link that is fixedly attached to one end of each watch winder unit and one or more secondary links pivotally coupled to the first link and to a rotatable shaft of the motor.

8. The watch winder drawer kit of claim 7, wherein the one or more secondary links comprises a second link and a third link, the second link being pivotally coupled to the first link and being coupled to the third link, the third link being coupled to the rotatable shaft of the motor.

9. The watch winder drawer kit of claim 7, wherein rotation of the shaft in a first direction is translated into movement of the plurality of watch winder units from the stored positions to the display positions and wherein rotation of the shaft in an opposite second direction is translated into movement of the plurality of watch winder units from the display positions to the stored positions.

10. The watch winder drawer kit of claim 5, wherein movement of the linkage in a first direction causes the plurality of watch winder units to move from the stored positions to the display positions and wherein movement of the linkage in a second direction causes the plurality of watch winder units to move from the display positions to the stored positions.

11. The watch winder drawer kit of claim 7, wherein the first link is fixedly attached to the one ends of the plurality of watch winder units at a location that is within the top 25% of the height of the one end.

12. The watch winder drawer kit of claim 1, wherein in the stored positions, the plurality of watch winder units are positioned at 90 degrees relative to the base and wherein in the display positions, the plurality of watch winder units are positioned at 60 degrees relative to the base.

13. The watch winder drawer kit of claim 1, wherein the sensor mechanism comprises a magnetic sensor.

14. The watch winder drawer kit of claim 1, wherein the magnetic sensor comprises a permanent magnet for attachment to the furniture and a magnetic sensing element that is adjustably coupled to the base.

15. The watch winder drawer kit of claim 14, wherein the magnetic sensing element is operatively connected to the main controller.

16. The watch winder drawer kit of claim 14, wherein the magnetic sensing element is coupled to a vertically oriented sensor arm that has an adjustable length to permit raising and lowering of the magnetic sensing element.

17. The watch winder drawer kit of claim 14, wherein the main controller has a power cord.

18. The watch winder drawer kit of claim 14, wherein the main controller receives a sensor output from the magnetic sensing elements and based on the sensor output, the processor outputs one of the first motor control signal and the second motor control signal.

19. The watch winder drawer kit of claim 1, wherein each watch winder is independently controllable.

20. The watch winder drawer kit of claim 1, wherein an underside of the base includes or more channels for routing wires.

21. The watch winder drawer kit of claim 1, wherein the base includes a through hole in which the main controller is disposed.

22. The watch winder drawer kit of claim 1, wherein the base includes through holes in which the plurality of watch winder units are at least partially received.

23. A watch winder drawer kit for installation in a drawer of a piece of furniture comprising:
a base having a top surface and an opposite bottom surface;
a watch winder unit having a housing that contains a plurality of rotatable watch winders, the watch winder unit being pivotally attached to the base to permit movement between a stored position and a display position;
a motorized first mechanism for controllably moving the watch winder unit between the stored position and the display position;
a sensor mechanism configured to determine whether the drawer is in a closed position or open position; and
a main controller operatively coupled to the motorized first mechanism and the sensor mechanism, the main controller being configured to send: (1) a first motor control signal to the motorized first mechanism to cause the watch winder unit to move from the stored position to the display position when the sensor mechanism detects that the drawer is in the open position; and (2) a second motor control signal to the motorized first mechanism to cause the watch winder unit to move from the display position to the stored position when the sensor mechanism detects that the drawer is being closed.
